(19) United States
(12) Patent Application Publication
(10) Pub. No.: US 2025/0150283 A1
(43) Pub. Date: May 8, 2025

(54) DATA TRANSMISSION PATH CHECKING SYSTEM, DATA TRANSMISSION PATH CHECKING METHOD, DATA RELAY SYSTEM, AND DATA RECEIVING APPARATUS

(71) Applicant: NEC Corporation, Minato-ku, Tokyo (JP)

(72) Inventor: Keisuke INA, Tokyo (JP)

(73) Assignee: NEC Corporation, Minato-ku, Tokyo (JP)

(21) Appl. No.: 18/838,334

(22) PCT Filed: Feb. 28, 2022
(86) PCT No.: PCT/JP2022/008169

§ 371 Date: Aug. 14, 2024

(51) Int. Cl. H04L 9/32; H04L 9/08

(52) U.S. Cl. CPC H04L 9/3247; H04L 9/0825; H04L 9/3263

(57) ABSTRACT

An authentication unit can transmit electronic certificates. A data transmission unit adds a signature and an electronic certificate to data and transmits the obtained data to a first data relay unit. The first data relay unit adds a signature and an electronic certificate to the received data and transmits the obtained data to a second data relay unit. The second data relay unit adds a signature and an electronic certificate to the received data and transmits the obtained data to a data receiving unit. The data receiving unit verifies, between the data receiving unit and the authentication unit, the electronic certificates cumulatively added to the received data, and checks a transmission path of the data based on the electronic signatures that have been cumulatively added.

### TECHNICAL FIELD

The present disclosure relates to a data transmission path checking system, a data transmission path checking method, a data relay system, and a data receiving apparatus.

### BACKGROUND ART

In a network system such as an Internet on Things (IoT) system where an enormous amount of data is transmitted, in order to secure authenticity of data, it is required to determine the presence or absence of data falsification when this data is distributed, the transmission source of this data, the distribution path of this data and so on.

In order to meet the above requirements, adding an electronic signature created using a private key to data to be transmitted and certifying authenticity of a public key that decodes the added electronic signature by an electronic certification have been widely performed (Patent Literature 1-3).

### CITATION LIST

### Patent Literature

[Patent Literature 1] International Patent Publication No. WO 2021/038684
[Patent Literature 2] Japanese Unexamined Patent Application Publication No. 2021-189715
[Patent Literature 3] International Patent Publication No. WO 2019/012626
[Patent Literature 4] Published Japanese Translation of PCT International Publication for Patent Application, No. 2020-511016

### SUMMARY OF INVENTION

### Technical Problem

However, in general, only an electronic signature and an electronic certificate of the processing entity of the previous stage that has transmitted data to a user are added to data received by the user, who corresponds to the data transmission destination. The data transmission source and processing entities such as a plurality of relay subjects (hereinafter the processing entities will be referred to as intermediate processing entities) are involved in the data transmission, and these intermediate processing entities each add an electronic signature and an electronic certificate to the data to be transmitted. However, the data added by the intermediate processing entities are generally deleted after they are verified by processing entities of the subsequent stages.

Therefore, the user cannot check the transmission path of the received data. Although it is possible to include metadata indicating the transmission path in the received data, it is impossible to secure authenticity of the transmission path indicated by the metadata. Therefore, in this case as well, the user cannot check whether the information on the transmission path of the received data is correct.

The present disclosure has been made in view of the aforementioned circumstances, and an object of the present disclosure is to enable a transmission path of data received by a user in a network system to be checked.

### Solution to Problem

A data transmission path checking system according to one aspect of the present disclosure includes: authentication means configured to be able to transmit signature authenticity information indicating authenticity of signature information; data transmission means for adding signature information of the data transmission means and signature authenticity information that corresponds to the signature information of the data transmission means acquired from the authentication means to transmission target data and outputting obtained data; one or more data relay means for cumulatively adding signature information of the data relay means and signature authenticity information that corresponds to the signature information of the data relay means acquired from the authentication means to the data received from the data transmission means and outputting obtained data; and data receiving means for verifying, between the data receiving means and the authentication means, the signature authenticity information cumulatively added by the one or more data relay means and checking a transmission path of the transmission target data based on the signature information cumulatively added by the one or more data relay means.

A data transmission path checking method according to one aspect of the present disclosure includes: storing, in authentication means configured to be able to transmit signature authenticity information indicating authenticity of signature information, the signature authenticity information; adding signature information of data transmission means and signature authenticity information that corresponds to the signature information of the data transmission means acquired from the authentication means to transmission target data and outputting obtained data; receiving, by one or more data relay means, data from the data transmission means, cumulatively adding, by the one or more data relay means, signature information of the data relay means and signature authenticity information that corresponds to the signature information of the data relay means acquired from the authentication means, and outputting obtained data; and verifying the signature authenticity information cumulatively added by the one or more data relay means with the authentication means and checking a transmission path of the transmission target data based on the signature information cumulatively added by the one or more data relay means.

A data relay means according to one aspect of the present disclosure includes: data acquisition means for acquiring, from data transmission means for adding signature information of the data transmission means and signature authenticity information that corresponds to the signature information of the data transmission means received from authentication means configured to be able to transmit signature authenticity information indicating authenticity of signature information to transmission target data and outputting obtained data, output data; information addition means for cumulatively adding signature information of the information addition means and signature authenticity information that corresponds to the signature information of the information addition means acquired from the authentication means to the data received by the data acquisition means; and data output means for outputting data to which the signature information and the signature authenticity information are added by the information addition means, in which data receiving means verifies, between the data receiving means and the authentication means, the cumulatively added signature authenticity information and checks a transmission path of the transmission target data based on the cumulatively added signature information.

A data receiving apparatus according to one aspect of the present disclosure includes: data acquisition means for receiving data from one or more data relay means, the one or more data relay means cumulatively adding signature information of the data relay means and signature authenticity information that corresponds to the signature information of the data relay means acquired from an authentication means to data received from data transmission means and outputting obtained data, the data transmission means adding, to transmission target data, signature information of the data transmission means and signature authenticity information that corresponds to the signature information of the data transmission means received from authentication means configured to be able to transmit signature authenticity information indicating authenticity of signature information and outputting obtained data; authenticity verification means for verifying the signature authenticity information cumulatively added to the data received by the data acquisition means with the authentication means; and transmission path checking means for checking a transmission path of the transmission target data based on the signature information cumulatively added.

### Advantageous Effects of Invention

According to the present disclosure, it is possible to check a transmission path of data received by a user in a network system.

### BRIEF DESCRIPTION OF DRAWINGS

FIG. 1 is a diagram schematically showing a configuration of a data transmission path checking system according to a first example embodiment;

FIG. 2 is a diagram schematically showing a configuration of a processing apparatus according to the first example embodiment;

FIG. 3 is a diagram schematically showing a configuration of a user terminal according to the first example embodiment;

FIG. 4 is a sequence diagram of an operation of a data transmission path checking system according to the first example embodiment;

FIG. 5 is a diagram showing an example of information included in an electronic certificate;

FIG. 6 is a diagram schematically showing a configuration of a data transmission path checking system according to a second example embodiment;

FIG. 7 is a diagram schematically showing a configuration of a processing apparatus according to the second example embodiment;

FIG. 8 is a sequence diagram of an operation of the data transmission path checking system according to the second example embodiment;

FIG. 9 is a diagram schematically showing a configuration of a data transmission path checking system according to a third example embodiment;

FIG. 10 is a diagram schematically showing a configuration of a company A's system according to the third example embodiment;

FIG. 11 is a sequence diagram of an operation of a data transmission path checking system according to the third example embodiment;

FIG. 12 is a diagram schematically showing a configuration of a data transmission path checking system according to a fourth example embodiment;

FIG. 13 is a diagram schematically showing a configuration of a company A's system according to the fourth example embodiment;

FIG. 14 is a flowchart of an operation of the company A's system according to the fourth example embodiment;

FIG. 15 is a diagram showing a case where both a processing apparatus and the company A's system have high scores; and

FIG. 16 is a diagram showing a case where the processing apparatus has a high score and the company A's system has a low score.

### EXAMPLE EMBODIMENT

Hereinafter, with reference to the drawings, example embodiments of the present disclosure will be described. Throughout the drawings, the same components are denoted by the same reference symbols and redundant descriptions will be omitted as necessary.

### First Example Embodiment

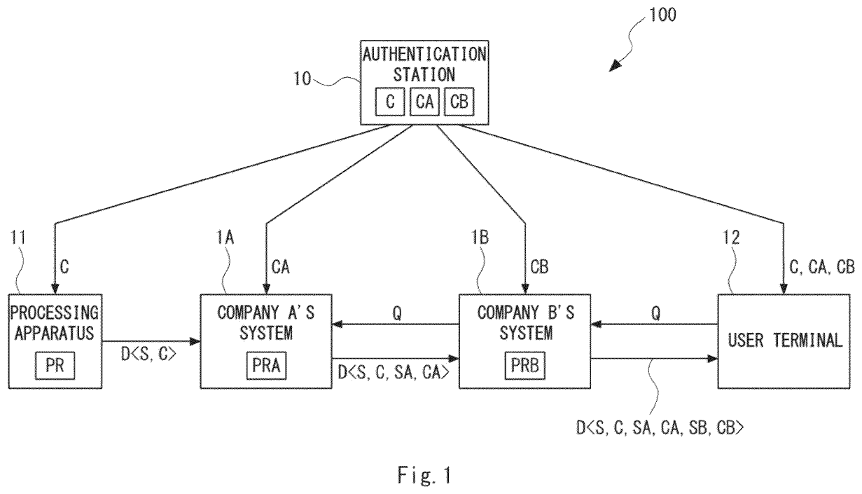

A data transmission path checking system according to a first example embodiment will be described. FIG. 1 schematically shows a configuration of a data transmission path checking system 100 according to the first example embodiment. In this example, an example in which data created by a company A is transmitted to a user via a company B will be described. The data transmission path checking system 100 includes an authentication station 10, a processing apparatus 11, a user terminal 12, a company A's system 1A, and a company B's system 1B.

The authentication station 10 stores electronic certificates C, CA, and CB that certify the authenticity of electronic signatures generated by the processing apparatus 11, the company A's system 1A, and the company B's system 1B, respectively, in advance. Then, the authentication station 10 provides the electronic certificates C, CA, and CB in accordance with a request (not shown) from the processing apparatus 11, the company A's system 1A, and the company B's system 1B. Further, the user terminal 12 can verify, between the user terminal 12 and the authentication station 10, the authenticity of the electronic certificates C, CA, and CB.

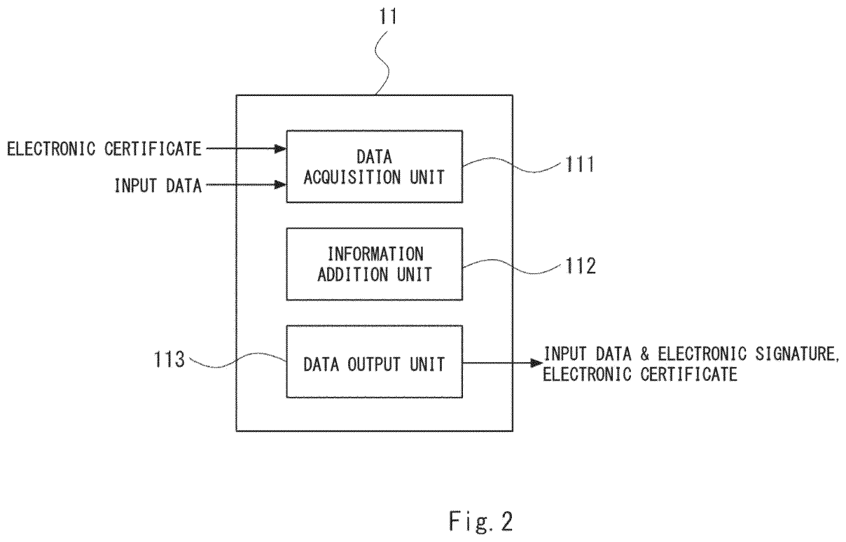

The processing apparatus 11 is configured as a data transmission apparatus that transmits data to be transmitted. FIG. 2 schematically shows a configuration of the processing apparatus 11 according to the first example embodiment. The processing apparatus 11 includes a data acquisition unit 111, an information addition unit 112, and a data output unit 113. The data acquisition unit 111 acquires an electronic certificate from the authentication station 10 and passes the acquired electronic certificate to the information addition unit 112. The information addition unit 112 generates an electronic signature, and adds the generated electronic signature and the acquired electronic certificate to input data, that is, data D to be transmitted. The data output unit 113 outputs, to the company A's system 1A, the data D to which the electronic signature and the electronic certificate are added.

The company A's system 1A and the company B's system 1B are each configured as a data relay system, and are each configured to have a configuration similar to that of the processing apparatus 11 or configured to have a processing apparatus similar to the processing apparatus 11. Like the processing apparatus 11, a data acquisition unit acquires an electronic certificate from the authentication station 10 and passes the acquired electronic certificate to an information addition unit. The information addition unit generates an electronic signature, and adds the generated electronic signature and the acquired electronic certificate to the input data, that is, the data received from the processing apparatus 11 or the company A's system 1A. The data output unit outputs, to the company B's system 1B or the user terminal 12, the data to which the electronic signature and the electronic certificate are added.

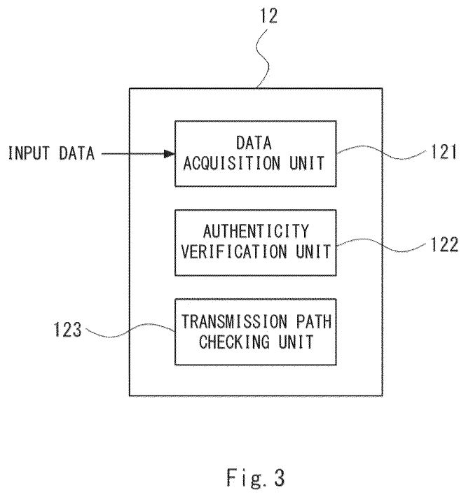

The user terminal 12 is configured as a data receiving apparatus. FIG. 3 schematically shows a configuration of the user terminal 12 according to the first example embodiment. The user terminal 12 includes a data acquisition unit 121, an authenticity verification unit 122, and a transmission path checking unit 123. The data acquisition unit 121 receives data transmitted from the company B's system 1B. The authenticity verification unit 122 verifies authenticity of the electronic certificate included in the received data. The transmission path checking unit 123 decodes the electronic signature and checks a transmission path of the received data.

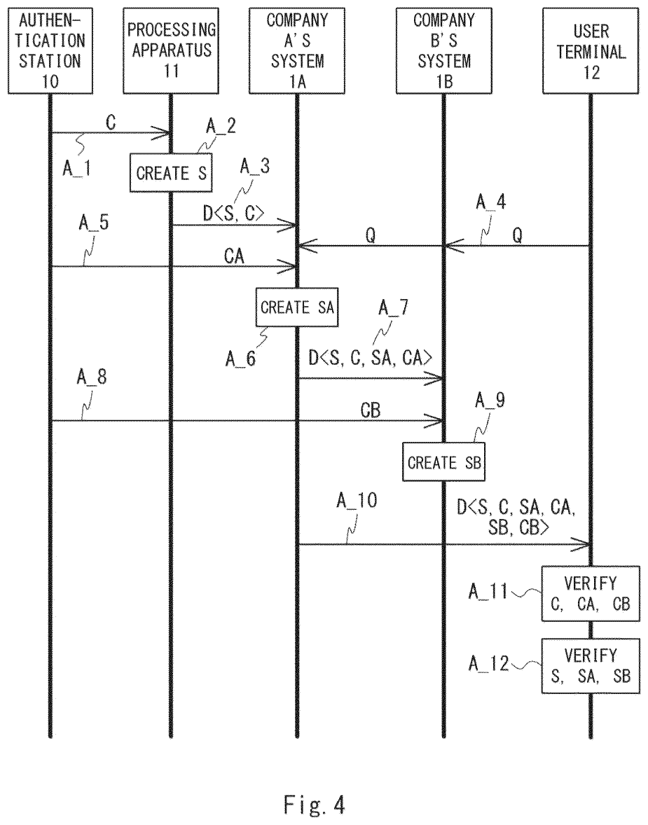

An operation of the data transmission path checking system 100 will be described. FIG. 4 shows a sequence diagram of the operation of the data transmission path checking system 100 according to the first example embodiment.

### Step A_1

The processing apparatus 11 is configured to transmit the data D to be transmitted to the user terminal 12 to which data is to be provided. The data acquisition unit 111 first receives, from the authentication station 10, an electronic certificate C including a public key PU for electronic signature and its identification information (information on the owner), which is information indicating that the processing apparatus 11 has issued the public key PU.

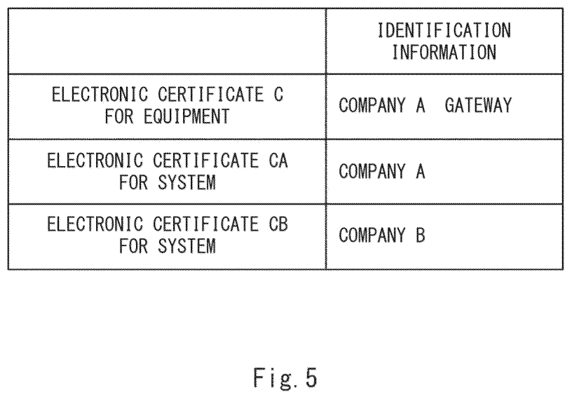

When an electronic certificate is issued for equipment such as a processing apparatus, an authentication station may include information on an entity to which the processing apparatus belongs and information indicating what equipment the processing apparatus is, in an electronic certificate as identification information. FIG. 5 shows an example of information included in the electronic certificate. In this example, the authentication station 10 may include information indicating that the processing apparatus 11 belongs to the company A and information indicating that the processing apparatus 11 is a gateway in the electronic certificate C as the identification information.

### Step A_2

The information addition unit 112 of the processing apparatus 11 creates, by a private key PR corresponding to the public key PU, an electronic signature S generated by encrypting, for example, a hash value generated from the data D.

### Step A_3

The information addition unit 112 of the processing apparatus 11 adds the electronic certificate C and the electronic signature S to the data D, and the data output unit 113 passes the data after the addition to the company A's system 1A connected to an external network. Accordingly, the company A's system 1A is able to transmit the data D to which the electronic certificate C and the electronic signature S are added, the data D being held in advance, in response to a request from another entity.

The company A's system 1A is able to store the data D to which the electronic signature S and the electronic certificate C are added in a storage apparatus or the like that is not shown, and transmit, when the company A's system 1A externally receives a query to request for transmission of the data D, the data D along with the electronic signature and the electronic certificate. In the description of this example, the user terminal 12 transmits a query Q to request the company A's system 1A to transmit the data D via the company B's system 1B.

### Step A_4

The data acquisition unit 121 of the user terminal 12 transmits the query Q to the company A's system 1A via the company B's system 1B in order to request the company A's system 1A to transmit the data D.

### Step A_5

Upon receiving the query Q, the data acquisition unit of the company A's system 1A receives, from the authentication station 10, an electronic certificate CA including a public key PUA for electronic signature and its identification information (information on the owner), that is, information indicating that the company A's system 1A has issued the public key PUA.

### Step A_6

The information addition unit of the company A's system 1A creates, by a private key PRA corresponding to the public key PUA, an electronic signature SA generated by encrypting, for example, a hash value generated from the data D.

### Step A_7

The information addition unit of the company A's system 1A further adds the electronic certificate CA and the electronic signature SA to the data D. That is, the company A's system 1A is able to cumulatively add the electronic certificate CA and the electronic signature SA to the data D to which the electronic certificate C and the electronic signature S have already been added. After that, the data output unit transmits the data after the addition to the company B's system 1B.

The company B's system 1B receives, from the company A's system 1A, the data D to which the electronic signatures S and SA and the electronic certificates C and CA are added, further adds an electronic signature and an electronic certificate, and transmits the obtained data to the user terminal 12.

### Step A_8

The data acquisition unit of the company B's system 1B receives, from the authentication station 10, an electronic certificate CB including a public key PUB for electronic signature and its identification information (information on the owner), that is, information indicating that the company B's system 1B has issued the public key PUB.

### Step A_9

The information addition unit of the company B's system 1B creates, by a private key PRB corresponding to the public key PUB, an electronic signature SB generated by encrypting, for example, a hash value generated from the data D.

### Step A_10

The information addition unit of the company B's system 1B further adds the electronic certificate CB and the electronic signature SB to the data D. That is, the company B's system 1B is able to cumulatively add the electronic certificate CB and the electronic signature SB to the data D to which the electronic certificates C and CA and the electronic signatures S and SA have already been added. After that, the data output unit transmits the data after the addition to the user terminal 12.

When an electronic certificate is issued for a target like a system that may include a plurality of equipment, the authentication station can include information on an entity to which the system belongs in the electronic certificate as the identification information. As shown in FIG. 5, the authentication station 10 may include information indicating that the company A's system 1A belongs to the company A in the electronic certificate CA as the identification information. Likewise, the authentication station 10 can include information indicating that the company B's system 1B belongs to the company B in the electronic certificate CB as the identification information.

### Step A_11

The data acquisition unit 121 of the user terminal 12 exchanges information with the authentication station 10 as necessary, whereby the authenticity verification unit 122 performs verification of authenticity of each of the electronic certificates C, CA, and CB cumulatively added to the data D with the authentication station 10, and confirms that the issuer of each of the electronic signatures S, SA, and SB cumulatively added to the data D is authentic.

### Step A_12

The transmission path checking unit 123 of the user terminal 12 decodes the electronic signatures S, SA, and SB by the public keys PU, PUA, and PUB. Accordingly, the user terminal 12 is able to check the subject that created the data D and its transmission path by checking the electronic signatures S, SA, and SB.

Accordingly, according to this configuration, it is possible to decode, by public keys whose issuers' authenticity has been verified, the electronic signatures cumulatively added to the data by the subject that has created the data and the subject(s) relaying the data transmission. Accordingly, it becomes possible to check the subject that has created the data and the transmission path of the data.

### Second Example Embodiment

In the first example embodiment, the configuration in which each of the plurality of processing entities such as equipment and a system adds an electronic signature and an electronic certificate to data has been described. In this case, the larger the number of processing entities, the larger the number of electronic signatures and the number of electronic certificates to be added to data, which causes an amount of data to increase. Therefore, when it is required to reduce an amount of data to be transmitted, it may be difficult to employ the configuration described in the first example embodiment.

In order to solve the above problem, in this example embodiment, a data transmission path checking system 200 which reduces an amount of data at a time of transmission in a case where electronic signatures and electronic certificates are cumulatively added to data by a plurality of processing entities will be described.

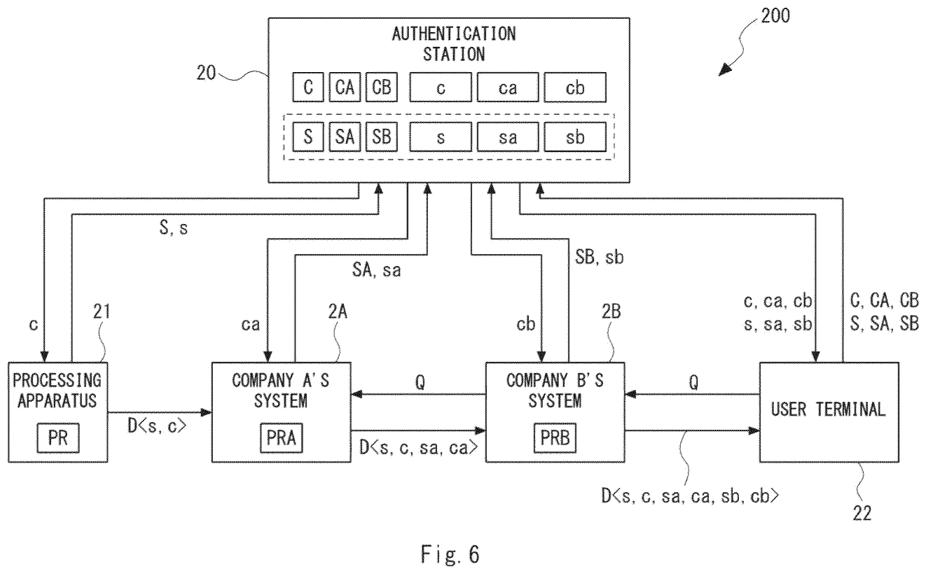

FIG. 6 schematically shows a configuration of the data transmission path checking system 200 according to the second example embodiment. The data transmission path checking system 200 includes an authentication station 20, a processing apparatus 21, a user terminal 22, a company A's system 2A, and a company B's system 2B. The authentication station 20, the processing apparatus 21, the user terminal 22, the company A's system 2A, and the company B's system 2B respectively correspond to the authentication station 10, the processing apparatus 11, the user terminal 12, the company A's system 1A, and the company B's system 1B of the data transmission path checking system 100.

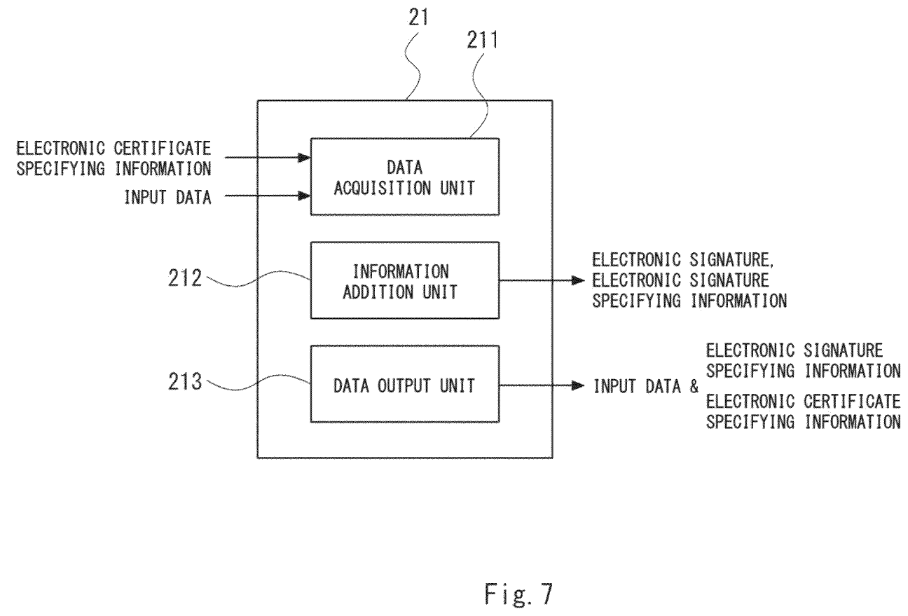

The processing apparatus 21 will be described. FIG. 7 schematically shows a configuration of the processing apparatus 21 according to the second example embodiment. The processing apparatus 21 includes a data acquisition unit 211, an information addition unit 212, and a data output unit 213. The data acquisition unit 211 acquires certificate specifying information that will be described later from the authentication station 20 and passes the acquired certificate specifying information to the information addition unit 212. The information addition unit 212 generates an electronic signature and signature specifying information that will be described later, and adds the generated signature specifying information and the acquired certificate specifying information to input data, that is, data D to be transmitted. Further, the information addition unit 212 transmits the electronic signature and the signature specifying information to the authentication station 20. The data output unit 213 outputs, to the company A's system 2A, the data D to which the signature specifying information and the certificate specifying information are added.

The company A's system 2A and the company B's system 2B each have a configuration similar to that of the processing apparatus 21 or include a processing apparatus similar to the processing apparatus 21. Like the processing apparatus 21, a data acquisition unit acquires certificate specifying information from the authentication station 20 and passes the acquired certificate specifying information to an information addition unit. The information addition unit generates an electronic signature and signature specifying information and adds the generated signature specifying information and the acquired certificate specifying information to the input data, that is, data received from the processing apparatus 21 or the company A's system 2A. Further, the information addition unit transmits the electronic signature and the signature specifying information to the authentication station 20. The data output unit outputs, to the company B's system 2B or the user terminal 22, the data to which the signature specifying information and the certificate specifying information are added.

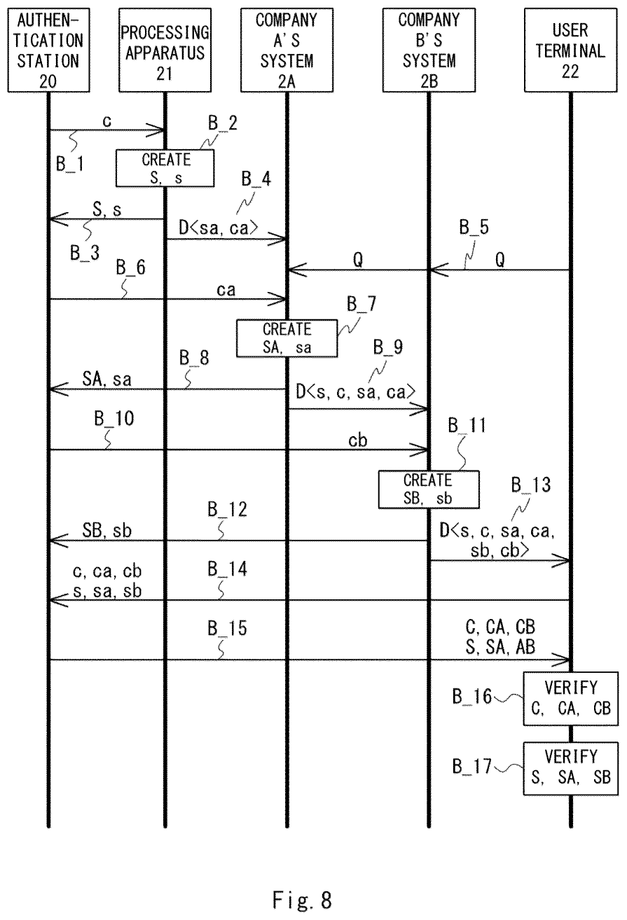

An operation of the data transmission path checking system 200 will be described. FIG. 8 shows a sequence diagram of the operation of the data transmission path checking system 200 according to the second example embodiment.

### Step B_1

The data acquisition unit 211 of the processing apparatus 21 receives, from the authentication station 20, certificate specifying information c, which is information for specifying the electronic certificate C. The certificate specifying information here is information that can be used to receive the electronic certificate specified by the certificate specifying information by presenting this information to the authentication station 20. The certificate specifying information may be, for example, an ID number or the like of the electronic certificate C.

### Step B_2

The processing apparatus 21 generates an electronic signature S by encryption that uses a private key PR corresponding to a public key PU which is to be certified by the electronic certificate C, the private key PR being held in the processing apparatus 21 in advance, and generates signature specifying information s that specifies the electronic signature S. The signature specifying information here is information that can be used to receive the corresponding electronic signature by presenting signature specifying information and an electronic signature corresponding to this signature specifying information to the authentication station 20 held in advance. The signature specifying information may be, for example, an ID number or the like of the electronic signature.

### Step B_3

The information addition unit 212 of the processing apparatus 21 transmits the electronic signature S and the signature specifying information s that have been generated to the authentication station 20, and the authentication station 20 holds the electronic signature S and the signature specifying information s that have been received.

### Step B_4

The information addition unit 212 of the processing apparatus 21 adds the certificate specifying information c and the signature specifying information s to the data D and the data output unit 213 passes the data after the addition to the company A's system 2A.

### Step B_5

The user terminal 22 transmits a query Q to the company A's system 2A via the company B's system 2B in order to request the company A's system 2A to transmit the data D.

### Step B_6

Upon receiving the query Q, the data acquisition unit of the company A's system 2A receives certificate specifying information ca, which is information for specifying the electronic certificate CA, from the authentication station 20.

### Step B_7

The information addition unit of the company A's system 2A generates an electronic signature SA by encryption that uses a private key PRA corresponding to the public key PUA which is to be certified by the electronic certificate CA, the private key PRA being held in the information addition unit of the company A's system 2A in advance, and generates signature specifying information sa for specifying the electronic signature SA.

### Step B_8

The information addition unit of the company A's system 2A transmits the electronic signature SA and the signature specifying information sa that have been generated to the authentication station 20, and the authentication station 20 holds the electronic signature SA and the signature specifying information sa that have been received.

### Step B_9

The information addition unit of the company A's system 2A further adds the certificate specifying information ca and the signature specifying information sa to the received data. That is, the company A's system 2A is able to cumulatively add the certificate specifying information ca and the signature specifying information sa to the data D to which the certificate specifying information c and the signature specifying information s have already been added. After that, the data output unit passes the data after the addition to the company B's system 2B.

### Step B_10

The data acquisition unit of the company B's system 2B receives the data transmitted from the company A's system 2A, and receives certificate specifying information cb, which is information for specifying the electronic certificate CB, from the authentication station 20.

### Step B_11

The information addition unit of the company B's system 2B generates an electronic signature SB by encryption that uses a private key PRB corresponding to the public key PUB which is to be certified by the electronic certificate CB, the private key PRB being held in the information addition unit of the company B's system 2B in advance, and generates signature specifying information sb for specifying the electronic signature SB.

### Step B_12

The information addition unit of the company B's system 2B transmits the electronic signature SB and the signature specifying information sb that have been generated to the authentication station 20, and the authentication station 20 holds the electronic signature SB and the signature specifying information sb that have been received.

### Step B_13

The information addition unit of the company B's system 2B further adds certificate specifying information cb and signature specifying information sb to the received data. That is, the company B's system 2B is able to cumulatively add the certificate specifying information cb and the signature specifying information sb to the data D to which the certificate specifying information c and ca and the signature specifying information s and sa have already been added. After that, the data output unit transmits the data after the addition to the user terminal 22.

### Step B_14

The user terminal 22 transmits the certificate specifying information c, ca, and cb and the signature specifying information s, sa, and sb that have been received to the authentication station 20.

### Step B_15

Accordingly, as a response from the authentication station 20, the user terminal 22 can acquire the electronic certificates C, CA, and CB and the electronic signatures S, SA, and SB.

### Step B_16

The user terminal 22 performs verification of authenticity of each of the electronic certificates C, CA, and CB corresponding to the certificate specifying information cumulatively added to the data D between the user terminal 22 and the authentication station 10, like in Step A_11 in FIG. 4, thereby confirming that each of issuers of the electronic signatures S, SA, and SB that correspond to the signature specifying information cumulatively added to the data D is authentic.

### Step B_17

The user terminal 22 decodes the electronic signatures S, SA, and SB by the public keys PU, PUA, and PUB, like in Step A_12 in FIG. 4. Accordingly, the user terminal 22 is able to check the subject that created the data D and its transmission path by checking the electronic signatures S, SA, and SB.

Accordingly, according to this configuration, like in the first example embodiment, electronic signatures cumulatively added to the data by the subject that has created the data and the subject(s) relaying the data transmission can be decoded by public keys whose issuers' authenticity has been verified. Accordingly, it becomes possible to check the subject that has created the data and the transmission path of the data.

Further, according to this configuration, instead of adding an electronic signature and an electronic certificate, signature specifying information and certificate specifying information whose amount of data is smaller than that of the electronic signature and the electronic certificate are added to the transmission target data, whereby it becomes possible to reduce the amount of data to be transmitted.

### Third Example Embodiment

In the first example embodiment, the data D reaches from the processing apparatus 11 to the user terminal 12 without being modified, that is, in a state in which the identity of this data D is maintained. However, a case in which, for example, the data D is processed in the company A's system 1A or the company B's system 1B in the middle of the transmission path may occur.

In this configuration, a data transmission path checking system capable of checking a transmission path in a case in which data is processed in the transmission process and detecting that the data has been processed in the path will be described.

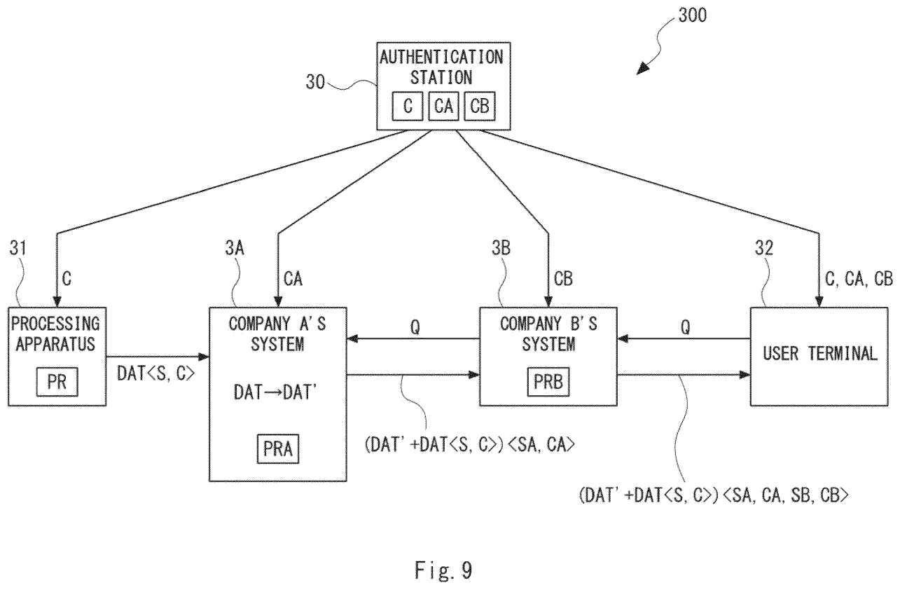

FIG. 9 schematically shows a configuration of a data transmission path checking system 300 according to the third example embodiment. The data transmission path checking system 300 includes an authentication station 30, a processing apparatus 31, a user terminal 32, a company A's system 3A, and a company B's system 3B. The authentication station 30, the processing apparatus 31, the user terminal 32, the company A's system 3A, and the company B's system 3B respectively correspond to the authentication station 10, the processing apparatus 11, the user terminal 12, the company A's system 1A, and the company B's system 1B of the data transmission path checking system 100. Since the processing apparatus 31, the company B's system 3B, and the user terminal 32 are respectively similar to the processing apparatus 11, the company B's system 1B, and the user terminal 12, the descriptions thereof will be omitted.

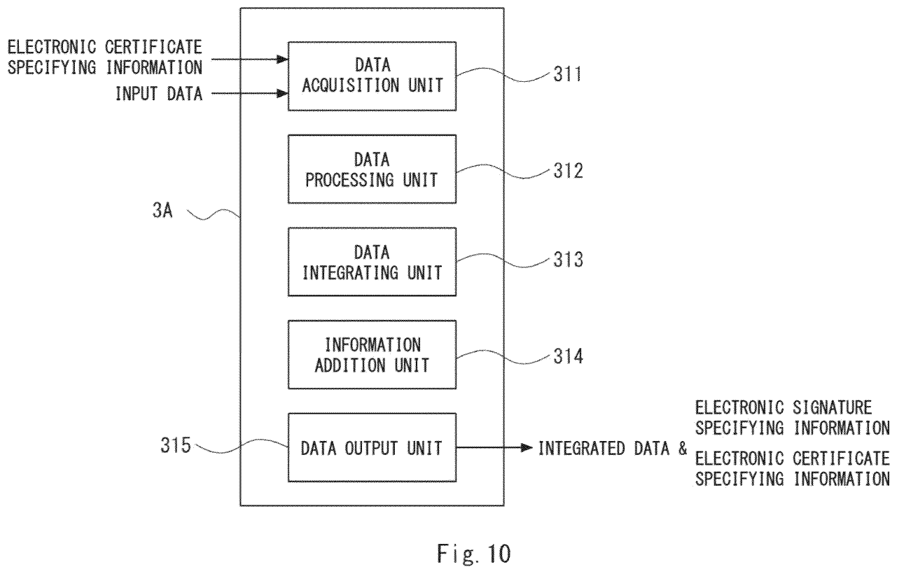

FIG. 10 schematically shows a configuration of the company A's system 3A according to the third example embodiment. The company A's system 3A includes a data acquisition unit 311, a data processing unit 312, a data integrating unit 313, an information addition unit 314, and a data output unit 315. The data acquisition unit 311 acquires an electronic certificate from the authentication station 30, and passes the electronic certificate to the information addition unit 314. The data processing unit 312 performs necessary processing on received data D to generate data D′. The data integrating unit 313 integrates the data D′ after the processing with the electronic signature and the electronic certificate added to the data D before the processing to obtain the integrated data. The information addition unit 314 generates an electronic signature and adds the generated electronic signature and the acquired electronic certificate to the integrated data. The data output unit 315 outputs, to the company B's system 3B, the integrated data to which the electronic signature and the electronic certificate are added.

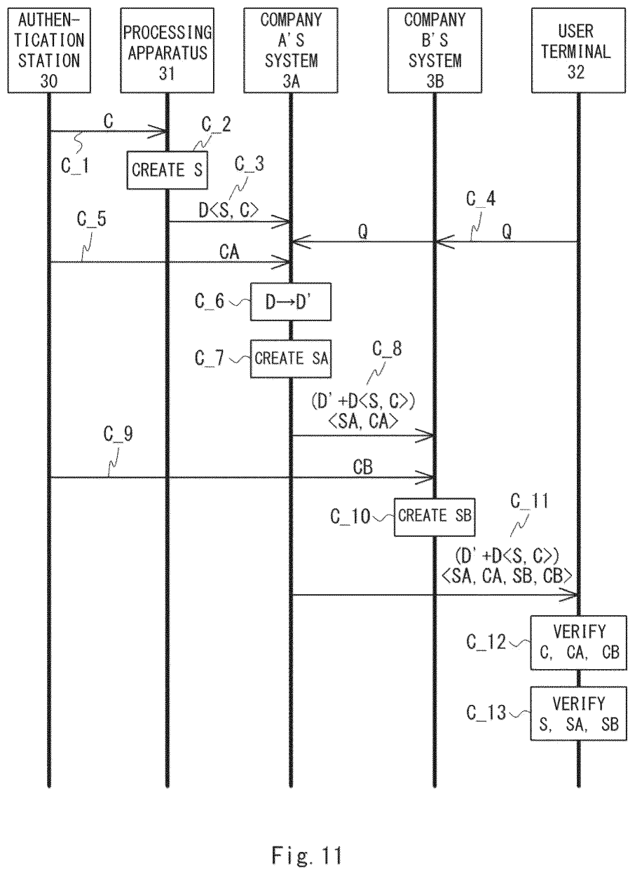

Next, an operation of the data transmission path checking system 300 will be described. FIG. 11 shows a sequence diagram of the operation of the data transmission path checking system 300 according to the third example embodiment.

### Steps C_1-C_5

Since Steps C_1-C_5 are respectively similar to Steps A_1-A_5 except that the processing apparatus 11 is replaced with the processing apparatus 31, the descriptions thereof will be omitted.

### Step C_6

The data processing unit 312 of the company A's system 3A performs necessary processing on the received data D, thereby creating data D′ after the processing.

### Step C_7

The information addition unit 314 of the company A's system 3A creates, by a private key PRA corresponding to the public key PUA, an electronic signature SA generated by encrypting, for example, a hash value generated from the data D′ after the processing.

### Step C_8

The data integrating unit 313 of the company A's system 3A converts the data D to which the electronic signature S and the electronic certificate CA are added and the data D′ created in Step C_6 into integrated data. Then, the information addition unit 314 cumulatively adds the electronic certificate CA and the electronic signature SA to the integrated data, and the data output unit 315 transmits data after the addition to the company B's system 3B. In FIG. 11, the integrated data is expressed by using parentheses, (D′+D<S,C>), and (D′+D<S,C>)<SA,CA> in which the electronic certificate CA and the electronic signature SA are cumulatively added to the integrated data (D′+D<S,C>), is transmitted to the company B's system 3B.

### Step C_9

The data acquisition unit of the company B's system 3B receives data transmitted in Step C_8 from the company A's system 3A. Then, the data acquisition unit of the company B's system 3B receives an electronic certificate CB including a public key PUB for electronic signature and its identification information (information on the owner), i.e., information indicating that the company B's system 3B has issued the public key PUB, from the authentication station 30, like in Step A_8 in FIG. 4.

### Step C_10

The information addition unit of the company B's system 3B creates, by a private key PRB corresponding to the public key PUB, an electronic signature SB generated by encrypting, for example, a hash value generated from the data D′ after the processing.

### Step C_11

The information addition unit of the company B's system 3B cumulatively adds the electronic certificate CB and the electronic signature SB to the received data, and the data output unit 315 transmits the data after the addition to the user terminal 32. FIG. 11 shows an example in which (D′+D<S,C>><SA,CA,SB, CB> where the electronic certificate CB and the electronic signature SB are cumulatively added to the received data (D′+D<S,C>)<SA,CA> is transmitted to the user terminal 32.

### Step C_12

The user terminal 32 performs verification of the authenticity of each of the electronic certificates CA and CB cumulatively added to the integrated data (D′+D<S,C>) and verification of the authenticity of the electronic certificate C added to the data D before the processing between the user terminal 32 and the authentication station 30, whereby it is possible to confirm that each of the issuers of the electronic signatures S, SA, and SB cumulatively added to the received data is authentic.

### Step C_13

The user terminal 32 decodes the electronic signatures S, SA, and SB by the public keys PU, PUA, and PUB. Accordingly, the user terminal 32 is able to check the subject that created the data D and its transmission path by checking the electronic signatures S, SA, and SB.

From the above description, the user terminal 32 can receive both the data D before the processing and the data D′ after the processing, whereby it is possible to recognize that the data D has been processed on the transmission path. Further, since the electronic signature S is added to the data D before the processing and the electronic signatures SA and SB are added to the integrated data including the data D′ after the processing, it is possible to recognize that the data D has been processed in the company A's system 3A.

Accordingly, according to this configuration, it is possible to decode the electronic signatures cumulatively added to the data by the subject that has created the data and the subject(s) relaying the data transmission by public keys whose issuers' authenticity has been verified. Accordingly, it becomes possible to check the subject that has created the data and the transmission path of the data.

Further, according to this configuration, as described above, when transmission target data is processed on a transmission path, it is possible to recognize the fact that the data has been processed and where this data has been processed.

Further, according to this configuration, it is possible to leave the evidence that data to be transmitted has been changed, whereby even in a case where the data to be transmitted is unintentionally tampered with, the fact of tampering can be detected.

### Fourth Example Embodiment

In the aforementioned example embodiments, a data transmission path checking system that cumulatively adds an electronic signature and an electronic certificate or signature specifying information and certificate specifying information to the data to be transmitted to the user terminal has been described. However, in this case, every time the equipment or the system receives electronic data, processing for generating an electronic signature is required. Further, when the transmission path of the data becomes complex, the number of electronic signatures received by the user terminal increases as well, which causes an amount of processing required for the signature check in the user terminal to be increased. Further, considering a situation where a large volume of data is transmitted in the network, it is possible that enormous computer resources may be consumed for signature generation and signature check in the entire network.

In this example embodiment, a data transmission path checking system capable of evaluating reliability of equipment and a network related to creation and relay of data and capable of omitting addition of an electronic signature and an electronic certificate of the equipment and the network whose reliability is secured will be described.

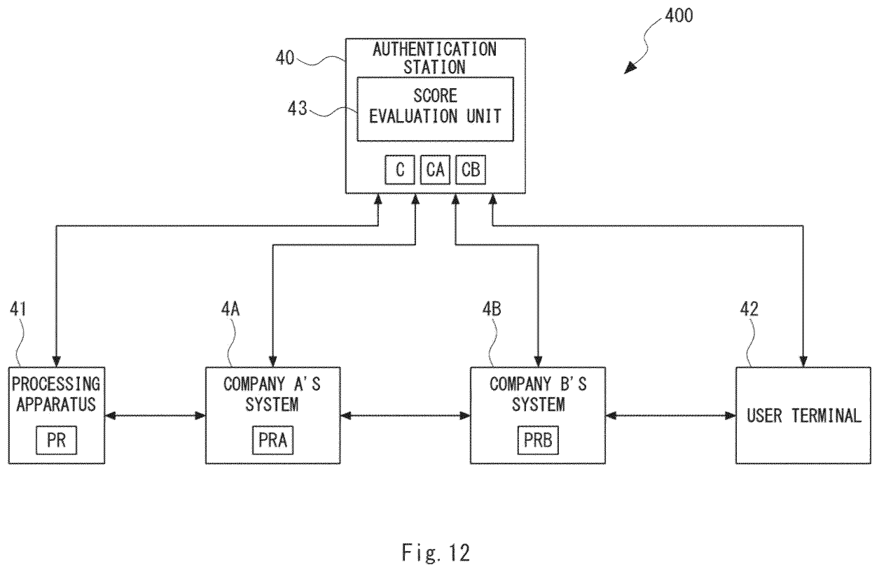

FIG. 12 schematically shows a configuration of a data transmission path checking system 400 according to the fourth example embodiment. The data transmission path checking system 400 includes an authentication station 40, a processing apparatus 41, a user terminal 42, a company A's system 4A, and a company B's system 4B. The authentication station 40, the processing apparatus 41, the user terminal 42, the company A's system 4A, and the company B's system 4B respectively correspond to the authentication station 10, the processing apparatus 11, the user terminal 12, the company A's system 1A, and the company B's system 1B of the data transmission path checking system 100. Since the processing apparatus 41 and the user terminal 42 are respectively similar to the processing apparatus 11 and the user terminal 12, the descriptions thereof will be omitted.

In this example, the authentication station 40 includes a score evaluation unit 43 that holds a score, which is an index indicating whether or not it is possible to guarantee the reliability of the processing apparatus 41, in advance. The score of the equipment or the system stored in the score evaluation unit 43 is determined in advance by referring to history information of predetermined items such as the manufacturer, the type, used parts, the user, or the purpose of the operation of the equipment or the system to be evaluated, and the latest state of the equipment or the system.

Note that the score may be updated to a different value as appropriate by monitoring the latest state of the equipment or the system. Accordingly, it is possible to change the score in accordance with the change in the situation and thus dynamically evaluate the reliability of the equipment or the system.

Since the configuration and the operation of the data transmission path checking system 400 are similar to those of the data transmission path checking system 100 except for the authentication station 40, the company A's system 4A, and the company B's system 4B, the configuration and the operation of the company A's system 4A will be mainly described in the following description.

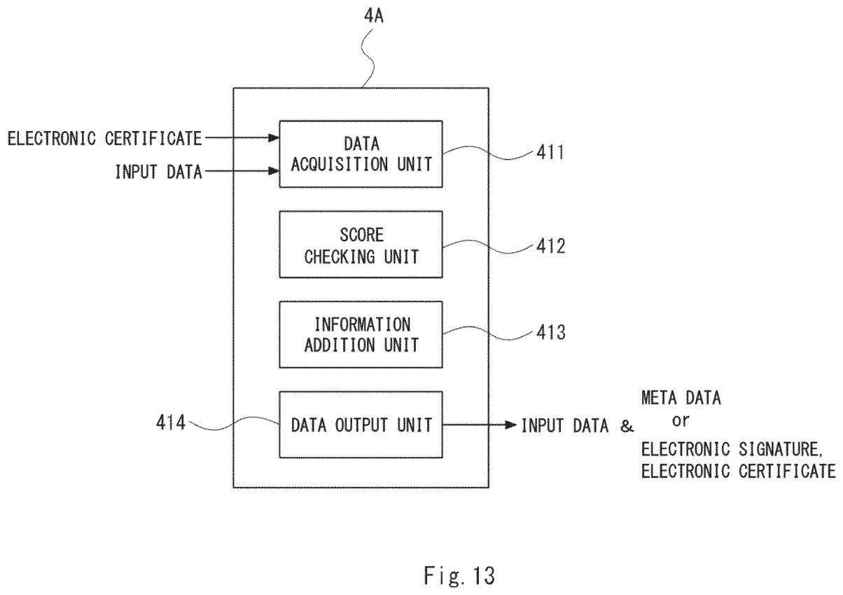

First, a configuration of the company A's system 4A will be described. FIG. 13 schematically shows a configuration of the company A's system 4A according to the fourth example embodiment. The company A's system 4A includes a data acquisition unit 411, a score checking unit 412, an information addition unit 413, and a data output unit 414. The data acquisition unit 411 acquires an electronic certificate from the authentication station 40 and passes the acquired electronic certificate to the information addition unit 413. The score checking unit 412 receives, from the score evaluation unit 43 of the authentication station 40, the score indicating reliability of the processing entity in the previous stage (subject that has created the data or a relay subject) that has transmitted the received data. Then, the score checking unit 412 determines whether or not the received score is a value that can guarantee the reliability of the entity that has transmitted the data. The information addition unit 413 deletes or keeps the electronic signature and the electronic certificate added to the received data in accordance with the result of the determination made in the score checking unit 412, and then further adds an electronic signature and an electronic certificate to the received data. The data output unit 414 outputs, to the company B's system 4B, data after the electronic signature and the electronic certificate are added.

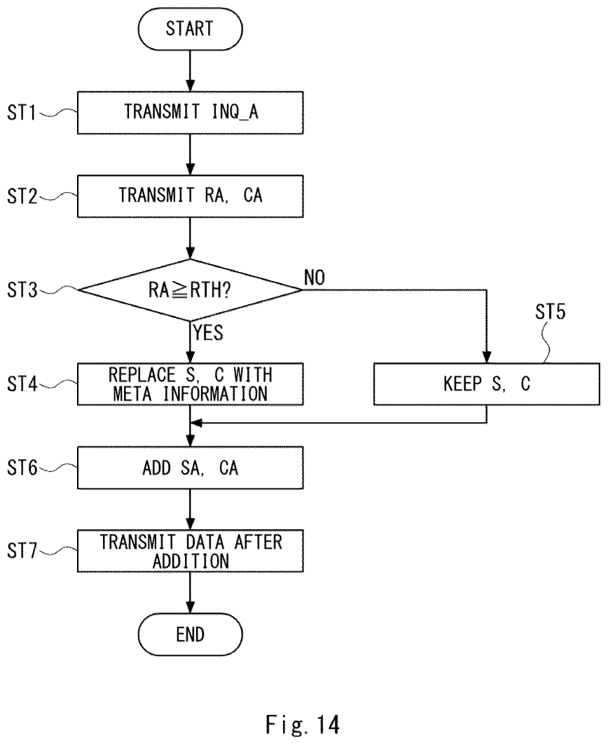

Next, an operation of the company A's system 4A will be described. FIG. 14 shows a flowchart of the operation of the company A's system 4A according to the fourth example embodiment.

### Step ST1

The data acquisition unit 411 transmits an inquiry INQ_A of the score indicating the reliability of the processing apparatus 41 of the previous stage to the authentication station 40.

### Step ST2

The score evaluation unit 43 transmits, in accordance with the inquiry INQ_A, a score RA indicating the reliability of the processing apparatus 41 to the company A's system 4A, and transmits the electronic certificate CA.

### Step ST3

The data acquisition unit 411 compares the score RA with a threshold RTH to determine whether or not the score RA is equal to or larger than the score RTH.

### Step ST4

When the score RA is equal to or larger than the threshold RTH, the information addition unit 413 replaces the received data, that is, the electronic signature S and the electronic certificate C added to the data D to which the electronic signature S and the electronic certificate C are added with meta information indicating that data has been received from the processing apparatus 41, which is the processing entity of the previous stage.

### Step ST5

When the score RA is smaller than the threshold RTH, the information addition unit 413 keeps the received data, that is, the data D to which the electronic signature S and the electronic certificate C are added as it is.

### Step ST6

The information addition unit 413 creates, by a private key PRA corresponding to the public key PUA, the electronic signature SA based on the data after Step ST4 or Step ST5.

### Step ST7

The data output unit 414 adds the electronic certificate CA and the electronic signature SA to the data after Step ST4 or ST5. That is, the company A's system 4A is able to cumulatively add the electronic certificate CB and the electronic signature SB to the meta information obtained by replacing the electronic certificate C and the electronic signature S in Step ST4, or to the data D to which the electronic certificate C and the electronic signature S are added kept in Step ST5. After that, the data output unit 414 transmits the data after the addition to the company B's system 4B.

Note that the configuration and the operation of the company B's system 4B are similar to those of the company A's system 4A. In the drawings, an inquiry of the score from the company B's system 4B to the authentication station 40 is denoted by INQ_B and the score received from the authentication station 40 is denoted by RB. Other redundant descriptions will be omitted.

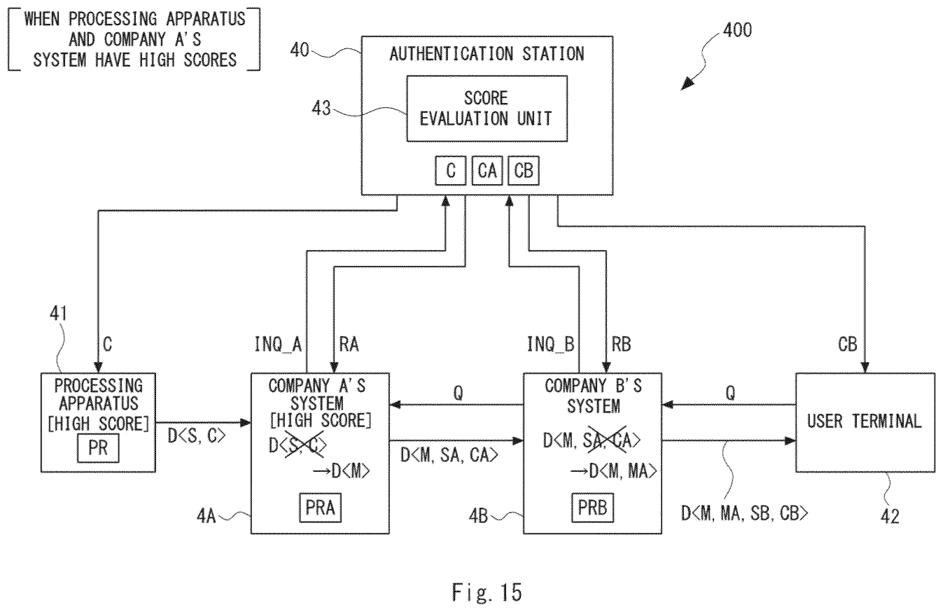

Next, an example of the operation of the data transmission path checking system 400 will be described. First, a case in which both the processing apparatus 41 and the company A's system 4A have high scores will be discussed. FIG. 15 shows a case in which both the processing apparatus 41 and the company A's system 4A have high scores.

In this example, the score RA of the processing apparatus 41 received by the company A's system 4A is equal to or larger than the threshold RTH. Therefore, the company A's system 4A deletes the electronic signature S and the electronic certificate C from the received data, that is, data D to which the electronic signature S and the electronic certificate C are added, and replaces the obtained data with meta information. After that, the company A's system 4A adds an electronic signature SA and an electronic certificate CA to the remaining data D and outputs the obtained data to the company B's system 4B.

The score RB of the company A's system 4A received by the company B's system 4B is equal to or larger than the threshold RTH. Therefore, the company B's system 4B deletes the electronic signature SA and the electronic certificate CA from the received data, that is, the data D to which the electronic signature SA and the electronic certificate CA are added, and replaces the obtained data with meta information. After that, the company B's system 4B adds the electronic signature SB and the electronic certificate CB to the remaining data D and outputs the obtained data to the user terminal 42.

As described above, when the reliability of the processing entity of the previous stage is high, the electronic signature and the electronic certificate added in the previous stage are replaced with meta information which indicates the path and whose amount of data is smaller. Accordingly, the amount of data to be transmitted can be compressed. Further, the reliability of the equipment and the system related to data transmission can be secured by evaluation using scores, whereby the user terminal 42 is able to check the transmission path of the data by referring to the meta information, like in the data transmission path checking system according to the aforementioned example embodiments.

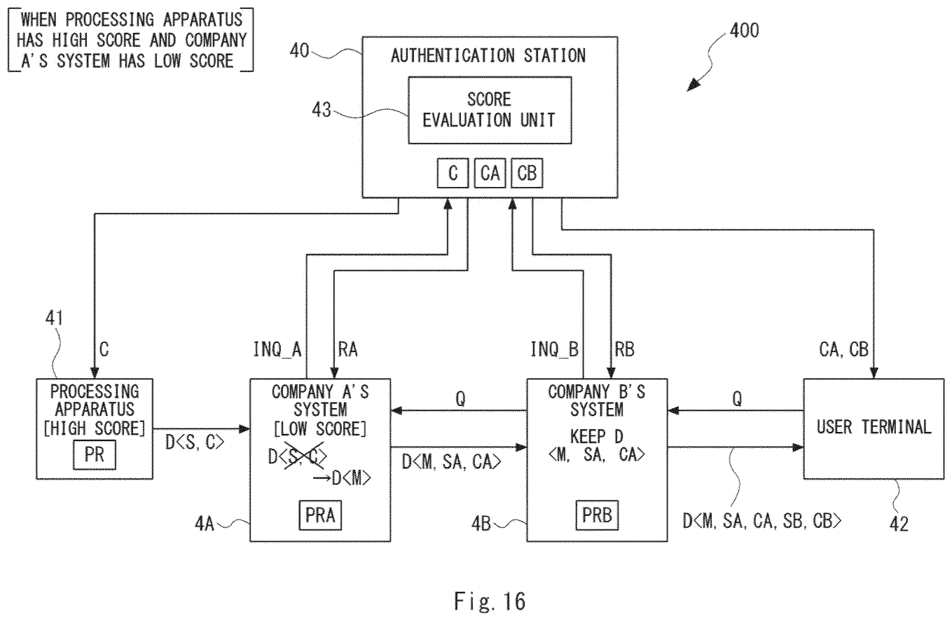

Next, a case in which the processing apparatus 41 has a high score and the company A's system 4A has a low score will be discussed. FIG. 16 shows a case in which the processing apparatus 41 has a high score and the company A's system 4A has a low score. Since the operation of the company A's system 4A is similar to that shown in FIG. 15, the descriptions thereof will be omitted.

An operation of the company B's system 4B will be described. In this example, the score RB of the company A's system 4A received by the company B's system 4B is smaller than the threshold RTH. Therefore, the company B's system 4B keeps the received data, that is, the data D to which the electronic signature SA and the electronic certificate CA are added as it is. After that, the company B's system 4B adds the electronic signature SB and the electronic certificate CB to the kept data, and outputs the obtained data to the user terminal 42.

As described above, in a case where the reliability of the processing entity of the previous stage is low, the electronic signature and the electronic certificate added in the previous stage are kept as they are. Accordingly, when reliability of equipment and a system related to data transmission cannot be secured by the evaluation using scores, it is possible to check the transmission path and the signature by the electronic signature and the electronic certification generated by the equipment or the system.

As described above, according to this configuration, evaluation using scores is applied, whereby it is possible to check the path of the transmission data, like in the data transmission path checking system according to the aforementioned example embodiments, while compressing transmission data.

### Other Example Embodiments

Note that the present invention is not limited to the aforementioned example embodiments and may be changed as appropriate without departing from the scope of the present invention. For example, the electronic signature and the electronic signature specifying information according to the aforementioned example embodiments are also simply referred to as signature information. The electronic certificate and the certificate specifying information according to the aforementioned example embodiments are merely referred to as signature authenticity information.

While the configuration in which the data transmission path checking system includes the company A's system and the company B's system, that is, two data relay systems, has been described in the aforementioned example embodiments, the data transmission path checking system may be configured to include only one data relay system or three or more data relay systems.

While the company A's system processes the transmission target data in the third example embodiment, the company B's system may also be configured to process the transmission target data, like the company A's system does. That is, some or all of one or more data relay systems included in the data transmission path checking system may have a configuration similar to that of the company A's system according to the third example embodiment.

In the data transmission path checking system according to the second example embodiment, like in the third example embodiment, some or all of one or more data relay systems may be configured to have a configuration similar to that of the company A's system according to the third example embodiment.

In the second and third example embodiments and modified examples thereof described above as well, like in the fourth example embodiment, the configuration in which the transmission data is compressed using scores may be employed.

In Step ST3 in FIG. 14, the example in which it is determined whether or not the score is equal to or larger than the threshold has been described, but this is merely an example. It may be determined whether the score is larger than the threshold.

Further, while the reliability is high when the score is large and the reliability is low when the score is small in the description of the fourth example embodiment, this is merely an example. The reliability may be low when the score is large and the reliability may be high when the score is small.

While the subject that has created the data (transmission source) is a processing apparatus configured to be equipment in the aforementioned example embodiments, this is merely an example. When it is not necessary to specify the equipment as the subject that has created the data (transmission source), the subject that has created the data (transmission source) may be a system composed of a plurality of pieces of equipment such as the company A's system and the company B's system or may be any other type of processing entity. Further, the subject(s) that relays data is not limited to a system such as the company A's system or the company B's system and may instead be any type of processing entity such as a single piece of equipment. Further, the user terminal is not limited to a single piece of equipment, and may be a system provided in each part or equipment included in the system.

In the drawings referred to in the aforementioned example embodiments, the processing apparatus, the company A's system, the company B's system, and the user terminal may exchange information via various kinds of network including a general network such as a communication line or the Internet. When the company A's system, the company B's system, and the user terminal are connected to one another via the network, the connection relation among them is not shown in the drawings because of its complexity. Further, in the drawings, the flow of information is indicated by arrow lines to facilitate visual understanding of the flow of information.

In the aforementioned example embodiments, the present invention has been described as a hardware configuration. However, this is merely an example. The present invention may implement the processing in the processing apparatus, the company A's system, the company B's system, and the user terminal by causing a Central Processing Unit (CPU) to execute a computer program. Further, the aforementioned program can be stored and provided to a computer using any type of non-transitory computer readable media. Non-transitory computer readable media include any type of tangible storage media. Examples of non-transitory computer readable media include magnetic storage media (such as flexible disks, magnetic tapes, hard disk drives, etc.), optical magnetic storage media (e.g. magneto-optical disks), CD-ROM (Read Only Memory), CD-R, CD-R/W, and semiconductor memories (e.g., mask ROM, PROM (Programmable ROM), EPROM (Erasable PROM), flash ROM, and RAM (Random Access Memory), etc.) The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

### REFERENCE SIGNS LIST

1A, 2A, 3A, 4A COMPANY A'S SYSTEM
1B, 2B, 3B, 4B COMPANY B'S SYSTEM
10, 20, 30, 40 AUTHENTICATION STATION
11, 21, 31, 41 PROCESSING APPARATUS
12, 22, 32, 42 USER TERMINAL
43 SCORE EVALUATION UNIT
100, 200, 300, 400 DATA TRANSMISSION PATH CHECKING SYSTEM
111, 121, 211, 311, 411 DATA ACQUISITION UNIT
112, 212, 314, 413 INFORMATION ADDITION UNIT
113, 213, 315, 414 DATA OUTPUT UNIT
122 AUTHENTICITY VERIFICATION UNIT
123 TRANSMISSION PATH CHECKING UNIT
312 DATA PROCESSING UNIT
313 DATA INTEGRATING UNIT
412 SCORE CHECKING UNIT
c, ca, cb CERTIFICATE SPECIFYING INFORMATION
C, CA, CB ELECTRONIC CERTIFICATE
D DATA
D′ DATA AFTER PROCESSING
PR, PRA, PRB PRIVATE KEY
s, sa, sb SIGNATURE SPECIFYING INFORMATION
S, SA, SB ELECTRONIC SIGNATURE

What is claimed is:

1. A data transmission path checking system comprising:
an authentication unit configured to be able to transmit signature authenticity information indicating authenticity of signature information;
a data transmission unit configured to add signature information of the data transmission unit and signature authenticity information that corresponds to the signature information of the data transmission unit acquired from the authentication unit to transmission target data and output obtained data;
one or more data relay units configured to cumulatively add signature information of the data relay unit and signature authenticity information that corresponds to the signature information of the data relay unit acquired from the authentication unit to the data received from the data transmission unit and output obtained data; and
a data receiving unit configured to verify, between the data receiving unit and the authentication unit, the signature authenticity information cumulatively added by the one or more data relay units and checking a transmission path of the transmission target data based on the signature information cumulatively added by the one or more data relay units.

2. The data transmission path checking system according to claim 1, wherein
the signature information is an electronic signature created using a private key, and
the signature authenticity information is an electronic certificate that certifies authenticity of a public key corresponding to the private key.

3. The data transmission path checking system according to claim 1, wherein
the signature information is signature specifying information that specifies an electronic signature created using a private key and whose amount of data is less than that of the specified electronic signature,
the signature authenticity information is certificate specifying information that specifies an electronic certificate certifying authenticity of a public key corresponding to the private key and whose amount of data is less than that of the specified electronic signature,
the data transmission unit and the one or more data relay units each generate the electronic signature and signature specifying information corresponding to the electronic signature and transmit the electronic signature and the signature specifying information to the authentication unit,
the authentication unit holds the plurality of electronic signatures and the plurality of pieces of signature specifying information that have been received and transmits the pieces of certificate specifying information that correspond to the respective electronic signatures to the data transmission unit and the one or more data relay units, and
the data receiving unit transmits, to the authentication unit, the plurality of pieces of signature specifying information and the plurality of pieces of certificate specifying information that have been cumulatively added and acquires a plurality of electronic signatures and a plurality of electronic certificates that correspond to the plurality of pieces of signature specifying information and the plurality of pieces of certificate specifying information that have been transmitted.

4. The data transmission path checking system according to claim 2, wherein
some or all of the one or more data relay units adds,
in a case where data to which the signature information and the signature authenticity information are added included in the received data is processed,
the signature information of the data relay unit and the signature authenticity information that corresponds to the signature information of the data relay unit to data in which the data before processing to which the signature information and the signature authenticity information are added is integrated with data after processing, and outputs obtained data.

5. The data transmission path checking system according to claim 1, wherein
the authentication unit holds a score indicating reliability of the one or more data relay units, and
each of the one or more data relay units:
queries a score of the data transmission unit of a previous stage or the data relay unit of a previous stage that has transmitted the received data to the authentication unit;
replaces, in a case where reliability of the data transmission unit of the previous stage or the data relay unit of the previous stage is guaranteed by the queried score, the signature information and the signature authenticity information added to the received data with meta information indicating that data has been received from the data transmission unit of the previous stage or the data relay unit of the previous stage; and
keeps, in a case where the reliability of the data transmission unit of the previous stage or the data relay unit of the previous stage is not guaranteed by the queried score, the signature information and the signature authenticity information added to the received data.

6. A data transmission path checking method comprising:
storing, in an authentication unit configured to be able to transmit signature authenticity information indicating authenticity of signature information, the signature authenticity information;
adding signature information of a data transmission unit and signature authenticity information that corresponds to the signature information of the data transmission unit acquired from the authentication unit to transmission target data and outputting obtained data;
receiving, by one or more data relay units, data from the data transmission unit, cumulatively adding, by the one or more data relay units, signature information of the data relay unit and signature authenticity information that corresponds to the signature information of the data relay unit acquired from the authentication unit, and outputting obtained data; and
verifying the signature authenticity information cumulatively added by the one or more data relay units with the authentication unit and checking a transmission path of the transmission target data based on the signature information cumulatively added by the one or more data relay units.

7. A data relay system comprising:
a data acquisition unit configured to acquire, from a data transmission unit configured to add signature information of the data transmission unit and signature authenticity information that corresponds to the signature information of the data transmission unit received from an authentication unit configured to be able to transmit signature authenticity information indicating authenticity of signature information to transmission target data and output obtained data, output data;
an information addition unit configured to cumulatively add signature information of the information addition unit and signature authenticity information that corresponds to the signature information of the information addition unit acquired from the authentication unit to the data received by the data acquisition unit; and
a data output unit configured to output data to which the signature information and the signature authenticity information are added by the information addition unit, wherein
a data receiving unit verifies, between the data receiving unit and the authentication unit, the cumulatively added signature authenticity information and checks a transmission path of the transmission target data based on the cumulatively added signature information.

8. A data receiving apparatus comprising:
a data acquisition unit configured to receive data from one or more data relay units, the one or more data relay units cumulatively adding signature information of the data relay unit and signature authenticity information that corresponds to the signature information of the data relay unit acquired from an authentication unit to data received from a data transmission unit and outputting obtained data, the data transmission unit adding, to transmission target data, signature information of the data transmission unit and signature authenticity information that corresponds to the signature information of the data transmission unit received from authentication unit configured to be able to transmit signature authenticity information indicating authenticity of signature information and outputting obtained data;
an authenticity verification unit configured to verify the signature authenticity information cumulatively added to the data received by the data acquisition unit with the authentication unit; and
a transmission path checking unit configured to check a transmission path of the transmission target data based on the signature information cumulatively added.
